(19) United States
(12) Patent Application Publication
(10) Pub. No.: US 2016/0055497 A1
(43) Pub. Date: Feb. 25, 2016

(54) METHOD AND POLLING SYSTEM FOR SUPPORTING EVALUATION OF A DELIVERED SERVICE

(71) Applicant: Telefonaktiebolaget L M Ericsson (publ), Stockholm (SE)

(72) Inventors: Mikael ANNEROTH, Enebyberg (SE); Joerg Niemoeller, Sundbyberg (SE); Nina Washington, Marsta (SE)

(21) Appl. No.: 14/463,889

(22) Filed: Aug. 20, 2014

(51) Int. Cl. G06Q 30/02; G06Q 40/06; H04L 29/08

(52) U.S. Cl. CPC G06Q 30/0203; H04L 67/10; G06Q 40/06

(57) ABSTRACT

A method and polling system (100) for supporting evaluation of a service. The polling system (100) first identifies (1:1) a user to whom the service has been delivered, and then polls (1:2) the user to provide an investment in the service such that the investment is correlated to the user's assessment of the service. When the investment is received (1:3) from the user, polling system (100) determines (1:4) a deviation of the investment from an average value of a distribution of investments received from other users, and also determines (1:5) a gain or loss relative the received investment based on the deviation. The polling system (100) further sends (1:6) an indication of the gain or loss to the user in response to the received investment. In this way, the user is motivated to return an investment to the polling system that is as close as possible to the average value, based on the user's understanding of how the service is likely to be perceived, since he/she will be rewarded by the gain if the deviation is small enough or zero.

### TECHNICAL FIELD

The present disclosure relates generally to a method and a polling system for supporting evaluation of a service that has been delivered to a user.

### BACKGROUND

When a service has been delivered by a service provider to one or more users, it is of interest for the service provider to know if the user is satisfied with the delivered service or if the service has shortcomings and needs to be improved in some way to make it more attractive to this user and to other users. Service providers are naturally interested in making their services as attractive as possible to their customers in order to increase sales, and a service may therefore be designed and developed so as to meet the users' demands and expectations as far as possible. It is also of interest to gain knowledge about what service(s) the customer is willing and happy to pay for, both today and in the future. The services discussed in this disclosure may, without limitation, be related to streaming of content such as music and video, on-line games, delivery of an article, web browsing, file downloads, voice and video calls, and so forth.

A normal way to obtain the users' opinion about a delivered service is to ask the customer, after delivery, to answer certain questions about the service. For example, the service provider may send out an inquiry form, questionnaire or opinion poll to the customer with various questions related to user satisfaction of the service and its delivery. If several users respond to such a poll or questionnaire, the results can be used for evaluating the service, e.g. for finding improvements to make. However, it is difficult to motivate the user to take the time and trouble to actually answer the questions and send a response back to the service provider. Users are often notoriously reluctant to provide their opinions on such matters, particularly considering the vast amounts of information and questionnaires flooding users in the current modern society. One way to motivate the user is to reward him/her in some way when submitting a response, e.g. by giving some present or a discount either on the purchased services or when buying future services, and so forth.

Even so, it is a problem that the user may provide opinions which are not really true and may thus be more or less misleading and useless for evaluation. For example, the user is often prone to forget how the service was actually perceived or experienced when it was delivered, even after a short while, once prompted to respond to such a questionnaire. Human memory thus tends to change over time, and the answer(s) given may not necessarily reflect what the user really felt at service delivery. The user may further provide answers very hastily and as simply as possible not caring if they are really true. The opinion provided may also be dependent on the user's current mood such that different opinions may be given at different occasions. It may thus be difficult to gain knowledge about what users find attractive and about their purchasing habits, predicted purchase needs and intentions, and so forth.

### SUMMARY

It is an object of embodiments described herein to address at least some of the problems and issues outlined above. It is possible to achieve this object and others by using a method and a polling system as defined in the attached independent claims.

According to one aspect, a method is performed by a polling system for supporting evaluation of a service. In this method, the polling system identifies a user to whom the service has been delivered and polls the user to provide an investment in the service such that the investment is correlated to the user's assessment of the service. The polling system then receives the investment from the user and determines a deviation of the received investment from an average value of a distribution of investments received from other users. The polling system further determines a gain or loss relative the received investment based on the deviation, and sends an indication of the gain or loss to the user in response to the received investment.

Thereby, the polling system is able to obtain information about how this service is experienced and appreciated by users in general since the polled user is stimulated to use his/her inherent knowledge and understanding of how other users would experience the service when deciding the investment, since the user has an opportunity to be rewarded in terms of a gain if the investment comes close to the distribution average value.

According to another aspect, a polling system is arranged to support evaluation of a service. The polling system comprises means configured to identify a user to whom the service has been delivered.

The polling system also comprises means configured to poll the user to provide an investment in the service such that the investment is correlated to the user's assessment of the service.

The polling system also comprises means configured to receive the investment from the user.

The polling system also comprises means configured to determine a deviation of the received investment from an average value of a distribution of investments provided by other users.

The polling system also comprises means configured to determine a gain or loss relative the received investment based on said deviation.

The polling system also comprises means configured to send an indication of the gain or loss to the user in response to the received investment.

The above method and polling system may be configured and implemented according to different optional embodiments to accomplish further features and benefits, to be described below.

A computer program is also provided comprising instructions which, when executed on at least one processor, cause the at least one processor to carry out either of the above methods. A carrier is also provided which contains the above computer program, wherein the carrier is one of an electronic signal, optical signal, radio signal, or a non-tangible computer readable storage medium.

### BRIEF DESCRIPTION OF DRAWINGS

The solution will now be described in more detail by means of exemplary embodiments and with reference to the accompanying drawings, in which:

FIG. 1 is a signaling diagram illustrating a procedure for supporting evaluation of a service from a user, according to some possible embodiments.

FIG. 2 is a flow chart illustrating a procedure in a polling system, according to further possible embodiments.

FIG. 3 is a diagram illustrating how a gain or loss can be determined, according to further possible embodiments.

FIG. 4 is a flow chart illustrating in more detail how a polling system may act in the procedure of FIG. 2, according to further possible embodiments.

FIG. 5 is a block diagram illustrating a polling system in more detail, according to further possible embodiments.

FIG. 6 is a block diagram illustrating how a polling system may be realized in practice, according to further possible embodiments.

### DETAILED DESCRIPTION

Briefly described, a solution is provided in a polling system to enable a useful and relevant evaluation of a service when it has been delivered to users by a service provider or similar. This can be accomplished by a polling procedure which aims to obtain some relevant and useful indication of the users' assessment of the service. First, a user is identified who has received and presumably experienced the service such that the user is able to acquire an opinion about how the service is perceived, e.g. in positive and/or negative terms. Next, the user is polled by the polling system and is asked to provide an “investment” in the service such that the investment is correlated to the user's assessment of the service, and the user is motivated to return his/her investment to the polling system as follows.

The term investment implies that the user has an opportunity to be rewarded in terms of a gain if the investment provided by the user is close to an average value of a distribution of investments received from other users, e.g. over time, or conversely be penalized in terms of a loss if the user's investment deviates to a certain extent from that average value. In this way, the user is encouraged and/or motivated to estimate or “guess” as truthful as possible how much the other users have generally invested in the service previously, based on their assessment of the service, by returning an investment that is as close as possible to the average value since he/she will be rewarded accordingly. Thereby, the polling system is able to obtain a perception about how this service is experienced and appreciated, not only by this particular user but also by users in general, by taking advantage of the user's inherent knowledge and understanding of how other users would experience the service which understanding would otherwise be unknown and not available to the polling system.

In the above rewarding scheme, the polling system maintains the average value of the investment distribution of multiple users having provided their investments in the service, and the average value may be updated whenever new investments are received from users in the polling procedure described herein. Each polled user will thus be rewarded if his/her investment is close enough to the current average value, which motivates the users to determine the investment based on his/her understanding. In this way, the polling system can extract that knowledge in order to support evaluation of the service. The polling procedure described herein thus introduces an element of gaming or gambling to the user by providing a reward by gain or a penalty by loss, depending on how much the returned investment deviates from the average value.

The gain or loss in this context may be realized in the form of currency added or reduced to/from an account of the user, or some virtual currency equivalents such as a score of points or the like which the user is able to convert into a reward such as free or discounted use of this service or others, or some gift or present which may or may not be related to the service. The solution is not limited to any specific form of realizing the gain or loss and the examples mentioned here are merely intended to be illustrative. The polling system may maintain a credit balance for the user and for any other users willing to participate in such a polling procedure, such that the credit balance is adjusted whenever the user has received a gain or loss as described herein. This credit balance of a user may be valid for any number of services that the polling system supports. Thus, the polling procedure described herein may be executed whenever a service supported by the polling system has been delivered to the user. The user may have been registered in beforehand as willing to participate.

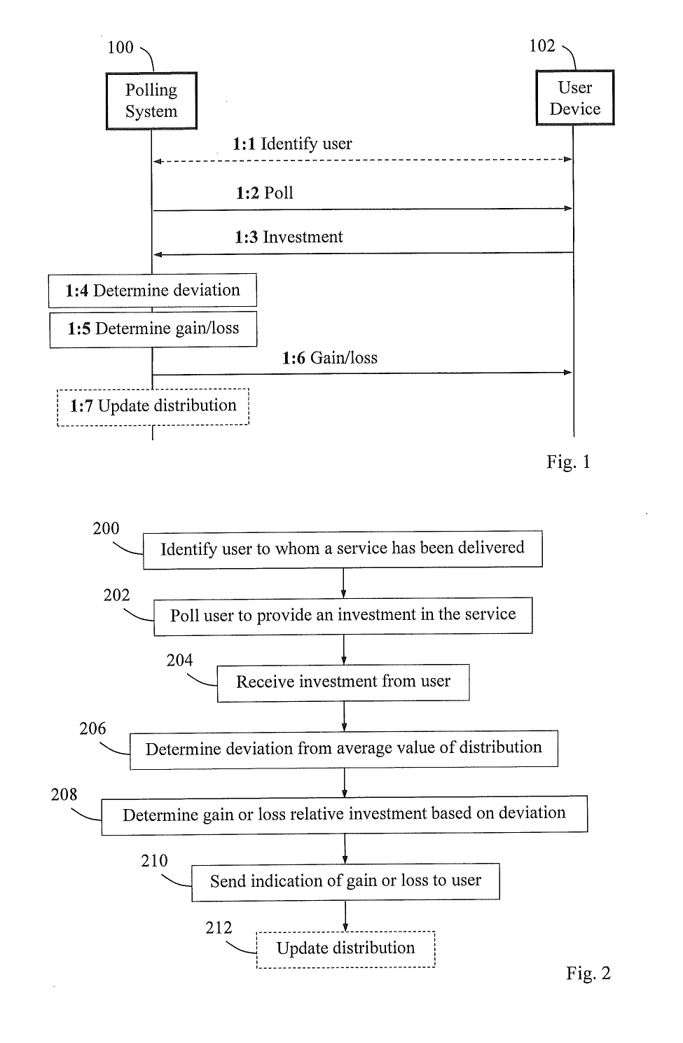

The solution will be described here in terms of features and actions in a polling system which is responsible for acquiring such investments in services from multiple users so that the investments can serve as a truthful basis for evaluating the service in terms of user satisfaction, e.g. in view of improving the service. The polling system may be implemented in a server or similar having suitable hardware and software configured to perform the actions to be described below. An example procedure for implementing the solution will now be described with reference to the signaling diagram in FIG. 1 involving a polling system 100 and a communication device 102 operated by the user, and also with reference to the flow chart in FIG. 2 illustrating actions performed by the polling system itself during the procedure.

A first action 1:1 in FIG. 1 corresponds to an action 200 in FIG. 2 which actions illustrate that the polling system 100 identifies a user to whom the service has been delivered, typically from a service provider such as a content server, a web server, a wireless network, etc., depending on the type of service. This action also includes identifying the user's device 102 in order to communicate with the user. For example, the polling system 100 may be notified by the service provider whenever the latter has delivered the service to a user. The delivered service may, without limitation, involve any of: streaming of content, on-line games, delivery of an article, web browsing, file downloads, and calls involving voice or video, to mention some illustrative examples. This action may also include checking if the user is willing to participate in the polling procedure, which may be indicated in a preference setting of the user or the like. The communication with the user in this procedure involves the communication device 102 of the user, and when referring to messages to/from the “user” herein for short it should be understood that the messages are communicated via the device 102.

Having found such a user, the polling system 100 sends a poll to the user's device 102, as shown in actions 1:2 and 202, respectively, the poll prompting the user to provide an investment in the service such that the investment is correlated to the user's assessment of the service. It is assumed that the polling system maintains an average value of a distribution of investments made by multiple users e.g. received over time, in the manner described above. It is also assumed that the user is aware of the possibility to be rewarded if he/she returns an investment close enough to the average value as described above, which is an incentive for the user to provide a response that is as truthful as possible in this respect.

In this context, “polling the user” may be performed in different ways. For example, the poll may be presented to the user in an e-mail, an SMS, an automatic voice call, or in the form of a web-based questionnaire, to mention some non-limiting examples. The solution is thus not limited to any particular way of polling the user. The user may further be prompted in the poll to select the investment from a set of alternatives, e.g. indicating monetary amounts or virtual scores. These choice alternatives may be presented to the user as different illustrations of customer satisfaction such as emotional icons, sometimes called “smileys”.

For example, if the user is very satisfied with the service delivery and believes that other users also have been satisfied with this service, he/she will believe that the average value of the investment distribution is relatively high. The user will therefore be motivated to select and return a high investment value that attempts to be as close as possible to the average value in order to get and a maximum gain from the polling system. On the other hand, if the user is not satisfied with the service delivery, he/she may believe that the average value is relatively low and is therefore motivated to select a low investment level attempting to return a similar or even equal value.

It should be noted that the current average value of the investment distribution is of course not known by the user and it should be kept secret to the user. It may also happen that the user for some reason believes that the other users have a different opinion of the service than himself/herself, e.g. due to some personal circumstances, and the user will in that case be inclined to return an investment believed to represent the other users rather than himself/herself. This information will actually be more valuable to the polling system than the user's own personal choice of investment would be, since his/her opinion is not representative or typical for all users in general.

A next action 1:3 and corresponding action 204 illustrate that the polling system 100 receives the investment returned by the user by means of the user device 102. In another action 1:4 and corresponding action 206, the polling system 100 determines a deviation of the received investment from the average value of a distribution of investments received from other users. This deviation is simply the difference between the received investment and the current average value. If the user manages to be spot on in his/her investment, the deviation will be zero. The polling system 100 further determines a gain or loss relative the received investment based on the determined deviation, as shown in actions 1:5 and 208, respectively. The gain is maximized if the deviation is zero, or at least less than some limit.

In this procedure it is assumed, as indicated above, that a certain amount of investments have already been received from a number of other users before sending any response with results to the users, so that the above-mentioned average value can be computed from the received investments to enable determination of a deviation and any gain or loss. Once a reasonably representative average value has been obtained, any deviation and resulting gain or loss can be determined as described herein.

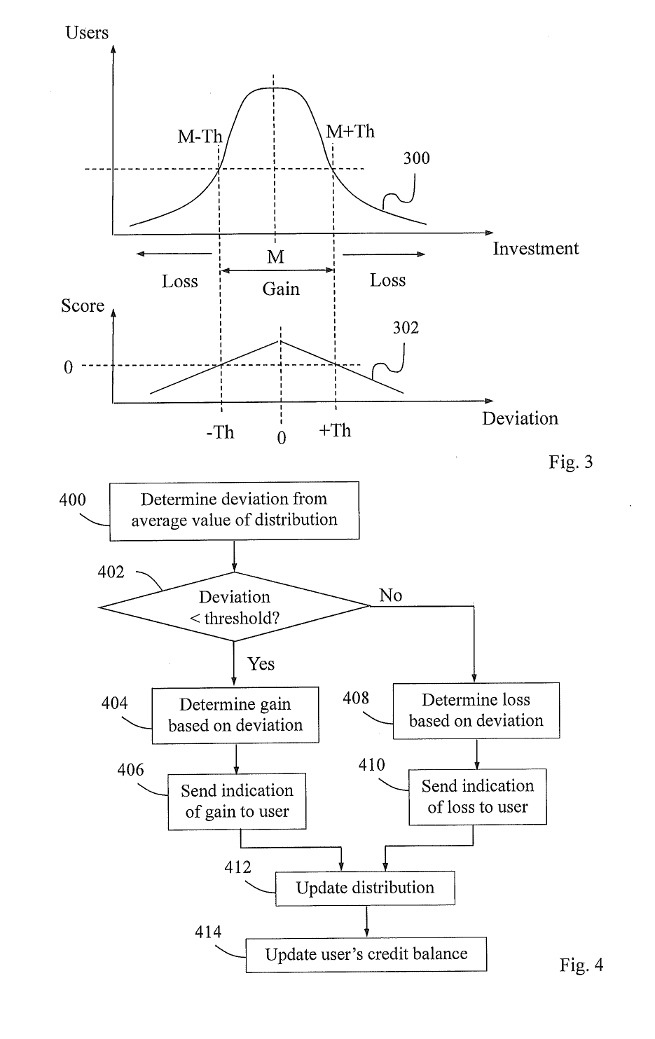

The gain or loss may be determined from the deviation in different ways, depending on how the polling procedure and its rewarding scheme are implemented. An example of how the above deviation may be related to the gain or loss is illustrated in FIG. 3. A first curve 300 shows the distribution of investments received from multiple users and the distribution is more or less symmetrically distributed around an average value “M”, which may also be called the median. A second curve 302 shows an example of how the resulting gain or loss in terms of a score, or currency, may depend on the deviation.

In a possible embodiment, the polling system determines a gain relative the received investment if the deviation is below a predefined threshold “Th”, i.e. when the received investment is within a region marked “Gain” in the figure, and the polling system conversely determines a loss relative the received investment if the deviation is above, or exceeds, the predefined threshold Th, i.e. when the received investment is in one of the two regions marked “Loss” in the figure. In other words, the polling system determines a gain when the received investment is between M-Th and M+Th, and determines a loss when the received investment is below M-Th or above M+Th.

In another possible embodiment, the gain or loss may be based on a difference between the received investment and the predefined threshold such that the threshold provides a transition between gain and loss. This means that a great deviation of the received investment from the average value M exceeding the threshold results in a negative score that provides a loss, and a small deviation less than the threshold results in a positive score that provides a gain as shown by the curve 302.

In the example of FIG. 3, the score of curve 302 is shown to be linearly proportional to the investment's deviation from the average value M, the score being positive, i.e. gain, for deviations between −Th and +Th, and the score being negative, i.e. loss, for deviations below −Th and above +Th. The score is thus a linear function of the deviation in this example, although any non-linear function may also be used. In another possible embodiment, the gain is maximized if the received investment coincides, more or less, with the average value M of the distribution of investments. In further possible embodiments, the gain and the loss are zero if the deviation corresponds to the predefined threshold −Th or +Th, which is illustrated in curve 302 at deviations of −Th and +Th where the score is zero relative the received investment.

FIG. 3 thus illustrates an example of how the score, representing a gain when above zero and a loss when below zero, may vary depending on the deviation, in this case linearly. However, the solution allows for any other variation of the gain and the loss depending on the deviation and the solution is not limited in this respect. The variation of gain and loss may thus alternatively be a non-linear function of the deviation, or a step-like function with a number of different discrete levels for different deviation intervals, and so forth.

Returning to the procedure illustrated by FIGS. 1 and 2, the polling system 100 further sends an indication of the gain or loss to the user, i.e. to the user device 102, as shown in actions 1:6 and 210, respectively, in response to the investment received in action 1:3 and action 204, respectively. Thereby, the user will see the results of his/her returned investment, that is, whether it has provided a gain or loss to the user, e.g. in terms of money or score points. If motivated, the polling system 100 may update the distribution of investments based on the investment received from the user, e.g. if the determined deviation exceeds a certain limit which warrants an adjustment of the current distribution, as shown in an optional action 1:7 and corresponding action 212, when the deviation is significant. The polling system 100 may optionally also send the updated credit balance to the user at some point, not shown. Alternatively, the user may maintain the current credit balance himself/herself, e.g. in the communication device.

This procedure enables the described polling system to evaluate the service in terms of customer satisfaction, based on the investment received from this user and also on investments in this service received from other users. By providing the gaming or gambling aspect in this procedure so that the user is stimulated by the chance of earning a gain by returning an investment as close as possible to the presumed average value, it is an advantage that the user is thereby motivated to determine a most likely investment, i.e. representative for all users to his/her best knowledge, which is not really possible with other reward-based polling procedures.

The user may be assumed to have a similar opinion about the service as the other users are alike peers in the sense that they consume the same service and the user will therefore have knowledge, or a feeling, of how the others have assessed the service. If the polling procedure is performed for more and more users, the average value will be adjusted towards a truthful value which is reliable and useful for evaluation the service. Another advantage is that the user is motivated to respond at all to the poll since the chance of getting a gain in this procedure is likely to be a significant incentive to the user.

An example of how the above-described procedure may be implemented in the polling system will now be described with reference to the flow chart in FIG. 4 when some of the above-described embodiments are employed. It is assumed that the polling system has already received an investment from a user, as described above for actions 1:1-1:3 and 200-204. A first action 400 illustrates that the polling system determines a deviation of the received investment from the average value of a distribution of investments received from other users, basically corresponding to actions 1:4 and 206.

The polling system then determines whether the deviation is below a predefined threshold, in an action 402, which may be the above-described threshold Th. If so, the polling system determines a gain based on the deviation in an action 404 and sends an indication of the gain to the user in another action 406. On the other hand, if the deviation exceeds the predefined threshold, the polling system determines a loss based on the deviation in an action 408 and sends an indication of the loss to the user in another action 410. In either case, the polling system updates the distribution of investments based on the investment received from the user, in a further action 412. A final action 414 illustrates that the polling system also updates a credit balance of the user depending on the outcome of action 402, that is either adding the gain thereto in case actions 404, 406 were performed, or deducting the loss therefrom in case actions 408, 410 were performed. The polling system may further send the updated credit balance to the user, not shown.

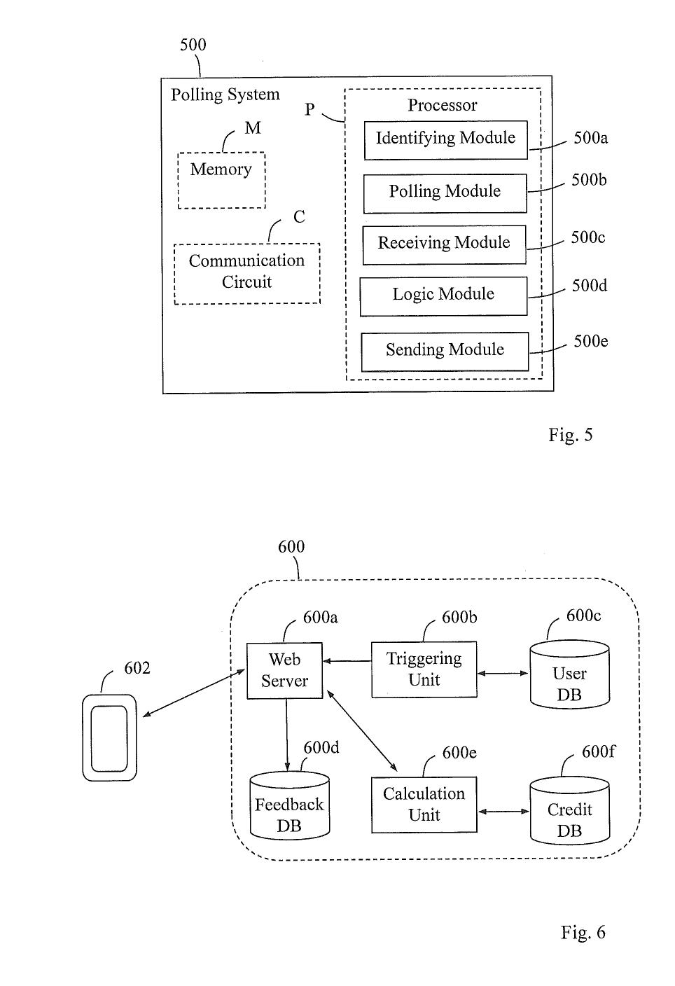

A detailed but non-limiting example of how a polling system may be structured with some possible functional entities such as modules, circuits or units, to bring about the above-described functionality of the polling system, is illustrated by the block diagram in FIG. 5. In this figure, the polling system 500 is arranged to support evaluation of a service. The polling system 500 may be configured to operate according to any of the examples and embodiments of employing the solution as described above and as follows. In particular, the polling system 500 may comprise means arranged or configured to perform at least the actions illustrated in FIGS. 1 and 2 and possibly also to operate according to FIGS. 3 and 4 in the manner described above and/or FIG. 6 to be described later below. In order to put any of this into practice, the polling system 500 may be implemented with a communication circuit C, a memory M and an operable processor P comprising various functional modules as described below.

More specifically, the polling system 500 comprises means configured to identify a user to whom the service has been delivered. This identifying operation may be performed by an identifying module 500a in the manner described for actions 1:1 and 200 above. The polling system 500 also comprises means configured to poll the user to provide an investment in the service such that the investment is correlated to the user's assessment of the service. This polling operation may be performed by a polling module 500b in the manner described for actions 1:2 and 202 above.

The polling system 500 also comprises means configured to receive the investment when returned from the user. This receiving operation may be performed by a receiving module 500c in the manner described for actions 1:3 and 204 above. The polling system 500 also comprises means configured to determine a deviation of the received investment from an average value of a distribution of investments provided by other users. This determining operation may be performed by a logic module 500d in the manner described for actions 1:4 and 206 above. The polling system 500 also comprises means configured to also determine a gain or loss relative the received investment based on said deviation. This determining operation may be performed by the logic module 500d in the manner described for actions 1:5 and 208 above. The polling system 500 also comprises means configured to send an indication of the gain or loss to the user in response to the received investment. This sending operation may be performed by a sending module 500e in the manner described for actions 1:6 and 210 above.

It should be noted that FIG. 5 illustrates some possible functional modules in the polling system 500 and the skilled person is able to implement these functional modules in practice using suitable software and hardware. Thus, the solution is generally not limited to the shown structures of the polling system 500, and the functional modules 500a-e may be configured to operate according to any of the features described in this disclosure, where appropriate.

The embodiments and features described herein may be implemented in a computer program comprising instructions which, when executed on at least one processor, cause the at least one processor to carry out the above actions e.g. as described for any of FIGS. 1, 2 and 4. Further, the above-described embodiments may be implemented in a carrier containing the above computer program, wherein the carrier is one of an electronic signal, optical signal, radio signal, or computer readable storage medium. The computer readable storage medium may be a compact disc or other carrier suitable for holding the computer program. Some examples of how the computer program and the carrier can be realized in practice are outlined below, with reference to FIG. 5.

The processor P may comprise a single Central Processing Unit (CPU), or could comprise two or more processing units. For example, the processor P may include a general purpose microprocessor, an instruction set processor and/or related chips sets and/or a special purpose microprocessor such as an Application Specific Integrated Circuit (ASIC). The processor P may also comprise a storage for caching purposes.

The memory M may comprise the above-mentioned computer readable storage medium or carrier on which the computer program is stored e.g. in the form of computer program modules or the like. For example, the memory M may be a flash memory, a Random-Access Memory (RAM), a Read-Only Memory (ROM) or an Electrically Erasable Programmable ROM (EEPROM).

Another non-limiting example of how a polling system may be implemented in practice in order to realize the above-described polling procedure, will now be briefly described with reference to the block diagram in FIG. 6. The polling system 600 is shown in communication with a user via a communication device 602. The polling system 600 comprises a web server 600a which is responsible for communicating messages with the device 602, including sending the above-described poll and receiving the investment returned by the user. These messages may be communicated by means of any suitable networks, links, interfaces and protocols, e.g. depending on the type of device 302, which is outside the scope of this solution. Further, the communication may be web-based, email-based, SMS-based, or based on a dedicated application, or “app”, installed at the user's device 602. Thus, the term web server is just an example.

The polling system 600 further comprises a triggering unit 600b which is responsible for initiating the described polling procedure, e.g. depending on information about the user retrieved from a user database 600c which may reside in the polling system 600 as shown in this figure, or alternatively at a service provider, not shown, which the triggering unit 600b can access. The triggering unit 600b basically detects when the service has been delivered to the user, e.g. as notified by the service provider, and may further check if the user is registered as willing to participate in the polling procedure, e.g. depending on user preferences or the like found in the user database 600c. If so, the triggering unit 600b sends a triggering signal or message to the web server 600a to start the polling procedure and the web server 600a sends the poll to device 602 and duly receives an investment returned from device 602.

The polling system 600 further comprises a feedback database 600d in which the web server 600a stores the received investment. The web server 600a also forwards the received investment to a calculation unit 600e which is responsible for determining the deviation and resulting gain or loss, if any. The calculation unit 600e then updates the user's credit balance which is maintained in a credit database 600f, and signals to the web server 600a to send a response containing the resulting gain or loss, if any, to the user's device 602.

While the solution has been described with reference to specific exemplifying embodiments, the description is generally only intended to illustrate the inventive concept and should not be taken as limiting the scope of the solution. For example, the terms “polling system”, “service”, “investment”, “deviation”, “gain” and “loss” have been used throughout this disclosure, although any other corresponding entities, functions, and/or parameters could also be used having the features and characteristics described here. The solution is defined by the appended claims.

1. A method performed by a polling system for supporting evaluation of a service, the method comprising:
identifying a user to whom the service has been delivered,
polling the user to provide an investment in the service such that the investment is correlated to the user's assessment of the service,
receiving the investment from the user,
determining a deviation of the received investment from an average value of a distribution of investments received from other users,
determining a gain or loss relative the received investment based on the deviation, and
sending an indication of the gain or loss to the user in response to the received investment.

2. The method according to claim 1, wherein the polling system determines a gain relative the received investment if the deviation is below a predefined threshold and a loss relative the received investment if the deviation is above the predefined threshold.

3. The method according to claim 2, wherein the gain or loss is based on a difference between the received investment and the predefined threshold.

4. The method according to claim 2, wherein the gain is maximized if the received investment coincides with the average value of the distribution of investments.

5. The method according to claim 2, wherein the gain and the loss are zero if the deviation corresponds to the predefined threshold.

6. The method according to claim 1, wherein the polling system updates the distribution of investments based on the investment received from the user.

7. A polling system arranged to support evaluation of a service, the polling system comprising means configured to:
identify a user to whom the service has been delivered,
poll the user to provide an investment in the service such that the investment is correlated to the user's assessment of the service,
receive the investment from the user,
determine a deviation of the received investment from an average value of a distribution of investments provided by other users,
determine a gain or loss relative the received investment based on said deviation, and
send an indication of the gain or loss to the user in response to the received investment.

8. The polling system according to claim 7, wherein the polling system is configured to determine a gain relative the received investment if the deviation is below a predefined threshold and a loss relative the received investment if the deviation is above the predefined threshold.

9. The polling system according to claim 8, wherein the polling system is configured to determine the gain or loss based on a difference between the received investment and the predefined threshold.

10. The polling system according to claim 8, wherein the polling system is configured to maximize the gain if the received investment coincides with the average value of the distribution of investments.

11. The polling system according to claim 8, wherein the gain and the loss are zero if the deviation corresponds to the predefined threshold.

12. The polling system according to claim 7, wherein the polling system is configured to update the distribution of investments based on the investment received from the user.

13. A computer program comprising instructions which, when executed on at least one processor, cause the at least one processor to carry out the method according to claim 1.

14. A carrier containing the computer program of claim 13, wherein the carrier is one of an electronic signal, optical signal, radio signal, or a non-transitory computer readable storage medium.
